(19) United States
(12) Patent Application Publication
(10) Pub. No.: US 2023/0133693 A1
(43) Pub. Date: May 4, 2023

(54) STEERING APPARATUS

(71) Applicant: Hitachi Astemo, Ltd., Hitachinaka-shi, Ibaraki (JP)

(72) Inventors: Satoshi Enomoto, Haga-gun, Tochigi (JP); Hiroaki Mori, Haga-gun, Tochigi (JP); Hiroshi Fujita, Haga-gun, Tochigi (JP)

(21) Appl. No.: 17/912,208

(22) PCT Filed: Apr. 10, 2020
(86) PCT No.: PCT/JP2020/016090

§ 371 Date: Sep. 16, 2022

(51) Int. Cl. B62D 5/04; B62D 3/12

(52) U.S. Cl. CPC B62D 5/0448; B62D 5/0424; B62D 3/12

(57) ABSTRACT

A steering apparatus includes a turning shaft movable in the vehicle widthwise direction, a pinion shaft meshed with the turning shaft, a first housing that retains therein the turning shaft and the pinion shaft, a ball screw that transmits drive force generated by a drive source to the turning shaft, and a second housing that retains therein the ball screw. A retaining portion capable of storing water is provided at an inner circumferential surface of the second housing. A lower end surface of the retaining portion is located below at least a lower end surface of the ball screw. A first end portion of the retaining portion in the axial direction of the turning shaft is located between a belt member that links the ball screw with the drive source and a rack end stopper at the drive-source side.

### TECHNICAL FIELD

The present disclosure relates to a steering apparatus.

### BACKGROUND ART

A steering apparatus is applied to a vehicle for steering. As for a technology regarding such a steering apparatus, Patent Document 1 discloses an electrically-assisted power steering device that includes an electric motor, a rack shaft coupled to a steering mechanism, and a power transmission mechanism that transmits power from the electric motor to the rack shaft. The power transmission mechanism includes a screw shaft which is connected to or integrated with the rack shaft, and which is provided with a male-screw thread, a nut which is placed around the screw shaft and which is provided with a female-screw thread, a plurality of rolling elements capable of rolling within a rolling passage formed between the male-screw thread and the female-screw thread, and a sleeve that includes a receiving portion which receives the power transmitted from the electric motor. The nut is internally fitted to the sleeve in such a way that the receiving portion is located outwardly in the radial direction relative to the rolling passage, and is to rotate together with such a sleeve.

### CITATION LIST

### Patent Literatures

Patent Document 1: JP2006-069517A

### SUMMARY OF INVENTION

### Technical Problem

The electrically-assisted power steering device disclosed in Patent Document 1 has a possibility such that water enters in a casing in which the ball screw, etc., is stored through, for example, matching surfaces of the respective components, and a belt that links the ball screw with a drive source is soaked with the entering water. When the belt is soaked with water, since it becomes difficult for the belt to move under a low-temperature environment at which freezing occurs, there is a technical disadvantage such that the performance of the steering apparatus is likely to decrease.

Hence, an objective of the present disclosure is to provide a steering apparatus that can maintain a performance under a freezing-temperature environment.

### Solution to Problem

Upon keen research and development, the inventors of the present disclosure obtained a technical knowledge such that, by providing a retaining portion that traps water entering in a housing in which a ball screw is stored below the lower end surface of the ball screw, a belt is not likely to be soaked with such water. Moreover, by providing a devisal that makes it difficult for water entering in a housing in which a pinion shaft is stored to move to the housing in which the ball screw is stored, the belt is also not likely to be soaked with such water. It is thought that providing such devisal facilitates a steering apparatus to maintain the performance under a freezing-temperature environment. The present disclosure has been made based on such technical knowledges. The present disclosure will be described below.

A steering apparatus according to the present disclosure includes:

a turning shaft movable in a vehicle widthwise direction;

a pinion shaft meshed with the turning shaft;

a first housing that retains therein the turning shaft and the pinion shaft;

a ball screw that transmits drive force generated by a drive source to the turning shaft; and

a second housing that retains therein the ball screw,

in which a retaining portion capable of storing water is provided at an inner circumferential surface of the second housing,

in which a lower end surface of the retaining portion is located below at least a lower end surface of the ball screw, and

in which a first end portion of the retaining portion in an axial direction of the turning shaft is located between a belt member that links the ball screw with the drive source and a rack end stopper at the drive-source side.

### Advantageous Effects of Invention

According to the present disclosure, a steering apparatus can be provided which can maintain a performance under a freezing-temperature environment.

### BRIEF DESCRIPTION OF DRAWINGS

FIG. 1 is a diagram for describing an electrically-assisted power steering device 100;

FIG. 2 is a diagram illustrating a retaining portion 57A and the surrounding thereof according to a first embodiment in an enlarged manner;

FIG. 3 is a diagram illustrating a part of the electrically-assisted power steering device 100 in an enlarged manner;

FIG. 4 is a diagram illustrating a retaining portion 57B and the surrounding thereof according to a second embodiment in an enlarged manner;

FIG. 5 is a diagram illustrating a retaining portion 57C and the surrounding thereof according to a third embodiment in an enlarged manner;

FIG. 6 is a diagram illustrating a part of an electrically-assisted power steering device 200 in an enlarged manner;

FIG. 7 is a diagram illustrating a part of the electrically-assisted power steering device 300 in an enlarged manner;

FIG. 8 is a diagram for describing an example form of a bottom portion of a retaining portion 57;

FIG. 9 is a diagram for describing an example form of a bottom portion of the retaining portion 57; and

FIG. 10 is a diagram for describing an example form of a bottom portion of the retaining portion 57.

### DESCRIPTION OF EMBODIMENTS

An electrically-assisted power steering device that is an example steering apparatus of the present disclosure will be described below with reference to the figures as needed. Note that the embodiments illustrated in the figures are merely examples of the present disclosure, and the present disclosure is not limited to the illustrated embodiments.

### 1. First Embodiment

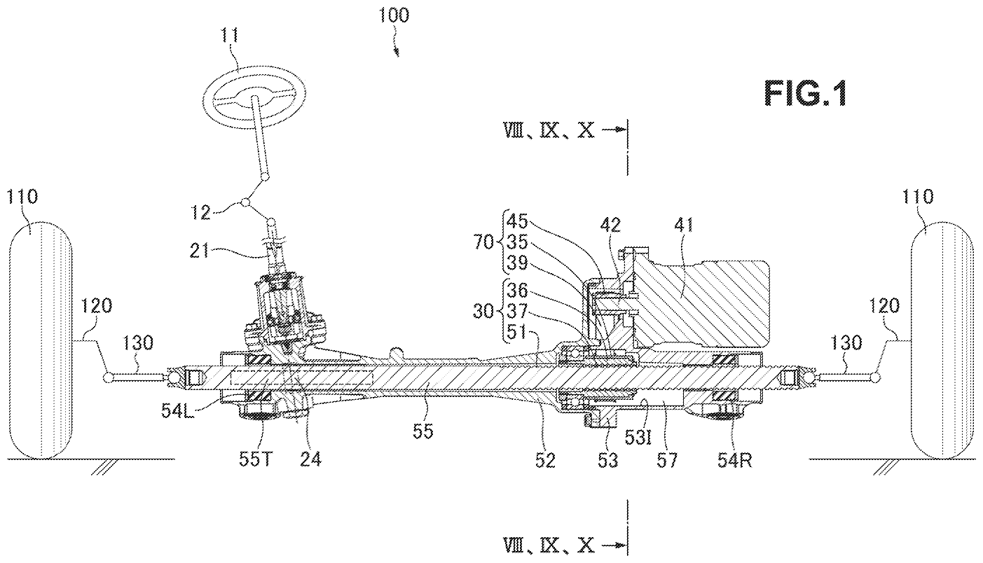

As illustrated in FIG. 1, an electrically-assisted power steering device 100 includes tie-rod ends 130 and 130 coupled to right and left wheels 110 and 110, respectively, through respective knuckles 120 and 120, and a rack shaft 55 coupled to the tie-rod ends 130 and 130. According to the electrically-assisted power steering device 100, steering force from a steering wheel 11 provided for a vehicle is transmitted to the rack shaft 55. A rack and pinion mechanism is formed by rack teeth 55 formed on the rack shaft 55 and pinion teeth 24 formed on the pinion shaft 21. The steering wheel 11 and the pinion shaft 21 are connected through an intermediate shaft 12, and the steering force from the steering wheel 11 is input to the intermediate shaft 12. Moreover, an unillustrated torsion bar is provided between the pinion shaft 21 and the intermediate shaft 12.

Moreover, the electrically-assisted power steering device 100 includes a motor 41 and a motor shaft 42 that is one of transmitting means that transmits drive force by the motor 41. The drive force by the motor 41 is transmitted to the rack shaft 55 as steering assist force through the motor shaft 42. This assists the movement of the rack shaft 55.

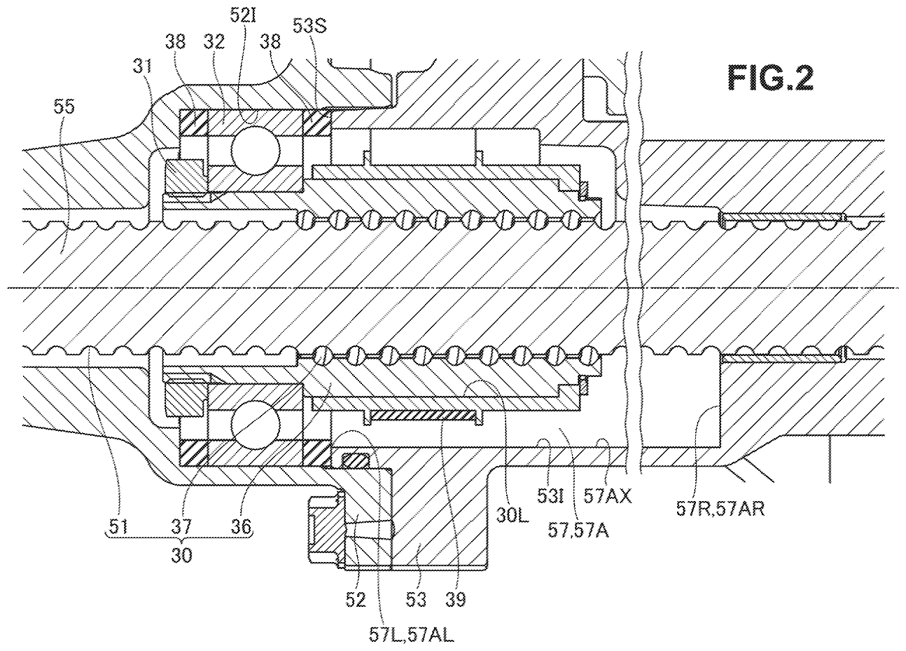

As illustrated in FIG. 1, the electrically-assisted power steering device 100 includes a first housing 52 and a second housing 53, and a retaining portion 57 at an inner circumferential surface 531 of the second housing 53 (in the following explanation, the retaining portion 57 of the first embodiment will be also referred to as a “retaining portion 57A”). The first housing 52 retains therein the rack shaft 55 that extends toward a side apart from the motor 41, and the second housing 53 retains therein the ball screw 30 and a transmission belt mechanism 70. As illustrated in FIG. 1 and FIG. 2, the retaining portion 57A includes a lower end surface 57AX provided below a lower end surface 30L of the ball screw 30 and the lower end surface of the transmission belt mechanism 70 (in the following description, the lower end surface of the retaining portion 57A may be also referred to as a “bottom portion 57AX”), and water entering in the second housing 53 can be trapped at the bottom portion 57AX.

The ball screw 30 is a kind of conversion mechanisms that converts rotational motion into linear motion, and transmits the drive force generated by the motor 41, i.e., assist torque, to the rack shaft 55. The ball screw 30 includes a ball screw portion 51 formed on the rack shaft 55, a plurality of balls 37, and a ball housing 36 coupled to the ball screw portion 51 through the balls 37. The ball housing 36 is supported by the first housing 52 so as to be freely rotatable through a bearing 32, and the movement is restricted in such a way that the ball housing 36 does not move in the axial direction of the rack shaft 55 independently from the bearing 32. The bearing 32 is fitted in an inner circumferential surface 521 of the first housing 52, and the inner race of the bearing 32 is fastened between a screw 31 and the ball housing 36 with such a race being depressed against the ball housing 36 by the screw 31. As illustrated in FIG. 2, an outer race of the bearing 32 has respective end surfaces in the axial direction of the rack shaft 55 held between elastic bodies 38, and the elastic bodies 38 are supported by the first housing 52 and by an end surface 53S with such an outer race being held between the first housing 52 and the end surface 53S of the second housing 53.

As illustrated in FIG. 1, the transmission belt mechanism 70 includes a drive pulley 45 provided at the motor shaft 42, a driven pulley 35 provided at the ball housing 36, and a belt member 39 tensioned between the drive pulley 45 and the driven pulley 35.

As illustrated in FIG. 1 and FIG. 2, the electrically-assisted power steering device 100 has the retaining portion 57A at a portion of the second housing 53 at the side of a matching surface with the first housing 52. The retaining portion 57A is placed between a rack end stopper 54R where a first end portion 57AR of the rack shat 55 in the axial direction is placed at an end of the rack shaft 55 at the motor-41 side and the belt member 39. Moreover, a second end portion 57AL of the rack shaft 55 in the axial direction which is an end portion at the belt-member-39 side relative to the first end portion 57AR is located at the pinion-shaft-21 side relative to both end surfaces of the belt member 39 in the axial direction of the rack shaft 55, and is an opening opened in the end surface of the second housing 53 facing with the elastic body 38 (i.e., an end surface 53S of the second housing 53 at the first-housing-52 side). By employing such a structure, since the elastic body 38 can be placed between the retaining portion 57A and the bearing 32, in comparison with a case in which no elastic body 38 is present, water that enters in the second housing 53 is not likely to contact the bearing 32. Consequently, the bearing 32 becomes not likely to be rusted out.

Moreover, since the second end portion 57AL is opened in the end surface 53S of the second housing 53, in a casting process of the second housing 53, a die for an inner-dimeter portion can be taken out in the opening direction. Consequently, an advantageous effect such that the easiness of casting improves can also be achieved.

The lower end surface of the retaining portion 57A is the bottom portion 57AX. The bottom portion 57AX is provided below a lower end surface 30L of the ball screw 30. More specifically, the bottom portion 57AX is placed below the belt member 39 that passes through the lower end surface of the ball housing 36 of the ball screw 30.

By providing the bottom portion 57AX below the lower end surface 30L of the ball screw 30 and the lower surface of the belt member 39, even if water enters in the second housing 53, such water can be trapped at the bottom portion 57AX. This prevents the ball screw 30 and the belt member 39 from being soaked with such water, and thus the electrically-assisted power steering device 100 can maintain the performance under a freezing-temperature environment.

In the retaining portion 57A, regarding the positions of the upper surface of the elastic body 38 placed below the rack shaft 55 and of the bottom portion 57AX in the vertical direction, either one may be located at the upper side. However, from the standpoint such that the electrically-assisted power steering device 100 can maintain the performance under a freezing-temperature environment by causing water entering in the second housing 53 to be easily trapped, it is preferable that the bottom portion 57AX should be placed below the upper surface of the elastic body 38 placed below the rack shaft 55.

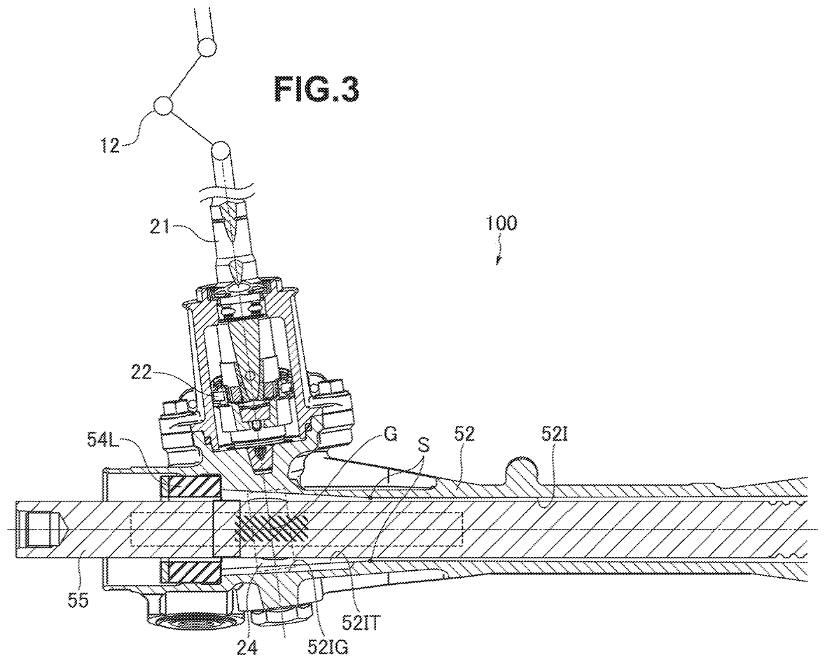

Conversely, as illustrated in FIG. 1 and FIG. 3, the first housing 52 retains therein the rack shaft 55. The inner circumferential surface 521 of the first housing 52 and the outer circumferential surface of the rack shaft 55 are not in contact with each other, but a clearance is formed therebetween. Moreover, the electrically-assisted power steering device 100 includes a torque sensor 22 that detects the steering torque applied to the steering wheel 11.

In the electrically-assisted power steering device 100, regarding the distance between the inner circumferential surface 521 of the first housing 52 and the outer circumferential surface of the rack shaft 55, it is far at a portion that surrounds a meshed portion G where the rack tooth 55T formed on the rack shaft 55 and the pinion tooth 24 formed on the pinion shaft 21 are meshed with each other, and the above-described distance becomes close as coming close to, from such a portion, the coupled portion between the first housing 52 and the second housing 53. The first housing 52 includes an inclined portion 52IT which is formed at the inner circumferential surface 521 and which becomes thin as coming close to the coupled portion between the first housing 52 and the second housing 53. The inclined portion 52IT is provided at a part of the inner circumferential surface 521, and a start point S of the inclined portion 52IT is located at the motor-41 side relative to the meshed portion G where the tooth 55T of the rack shaft 55 and the tooth 24 of the pinion shaft 21 are meshed with each other. The rack end stopper 54L is provided at the end portion of the rack shaft 55 at the pinion-shaft-21 side.

As illustrated in FIG. 3, the electrically-assisted power steering device 100 further includes, in addition to the inclined portion 52IT, a groove portion 52IG which is formed at the inner circumferential surface 521 of the first housing 52 facing with the rack shaft 55 and located below the rack shat 55, and which has an opened upper end and a lower end as a bottom portion. By providing such a groove portion 52IG, even if water enters in the first housing 52, such water can be trapped at the groove portion 52IG. Furthermore, by providing the inclined portion 52IT, even if water enters in the first housing 52, it is difficult for the water trapped below the rack shaft 55 to move toward the second-housing-53 side. Accordingly, since the amount of water that flows in the second housing 53 from the first housing 52 can be reduced, the ball screw 30 and the belt member 39 can be further prevented from being soaked with such water. That is, by providing the retaining portion 57A, the inclined portion 52IT, and the groove portion 52IG, the ball screw 30 and the belt member 39 can be prevented from being soaked with water. Therefore, according to the first embodiment of the present disclosure, the electrically-assisted power steering device 100 can be provided which can maintain the performance under a freezing-temperature environment.

In the above description relating to the first embodiment, although a structure has been described in which the second end portion 57AL in the axial direction of the rack shaft 55 is located at the pinion-shaft-21 side relative to both end surfaces of the belt member 39 in the axial direction of the rack shaft 55, and is an opening which is opened in the end surface 53S of the second housing 53 facing the elastic body 38, the first embodiment is not limited to this structure. The second end portion of the retaining portion can be in other forms. The other forms thereof will be described below.

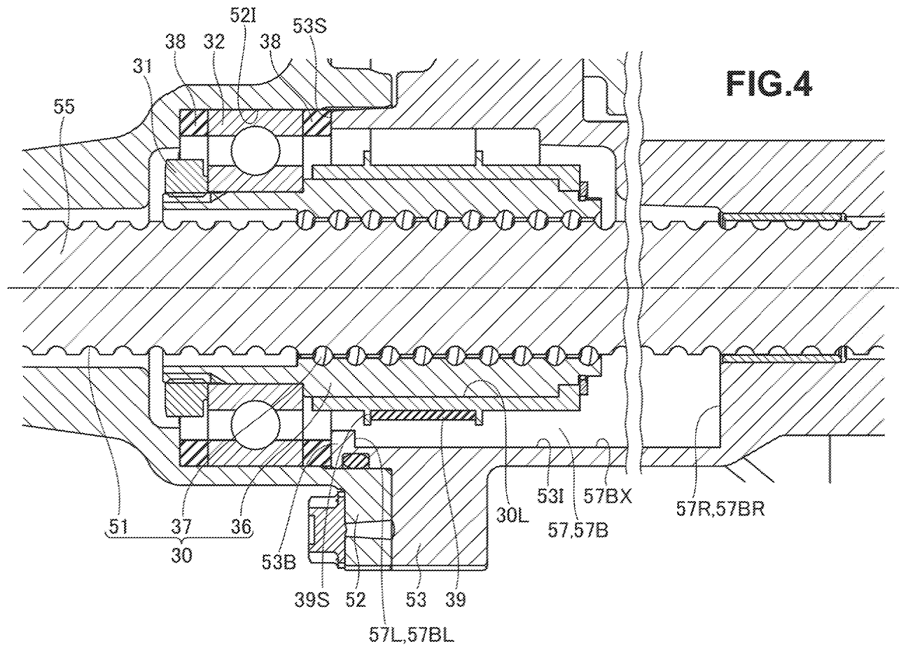

FIG. 4 is a diagram for describing a retaining portion 57B that is in a different form from that of the above-described retaining portion 57A. The retaining portion 57B illustrated in FIG. 4 has a first end 57BR located at the similar position to that of the above-described first end 57AR, but the form of a second end portion 57BL differs from that of the second end portion 57AL. The second end portion 57BL of the retaining portion 57B has a position in the axial direction of the rack shaft 55 that is the same as the position of a side face of, at the rack-end-stopper-54R side, a convexity 53B provided at the end of a bottom portion 57BX in the retaining portion 57B at the elastic-body-38 side. In other words, the second end portion 57BL is located between the position of a side face 39S of the belt member 39 at the pinion-shaft-21 side, and an end surface 53S of the second housing 53 at the pinion-shaft-21 side. By employing such a form, it becomes easy to trap water in the retaining portion 57B by what corresponds to the height of the convexity 53B. Consequently, since it becomes easy to prevent the belt member 39 from being soaked with water, the electrically-assisted power steering device 100 can maintain the performance under a freezing-temperature environment.

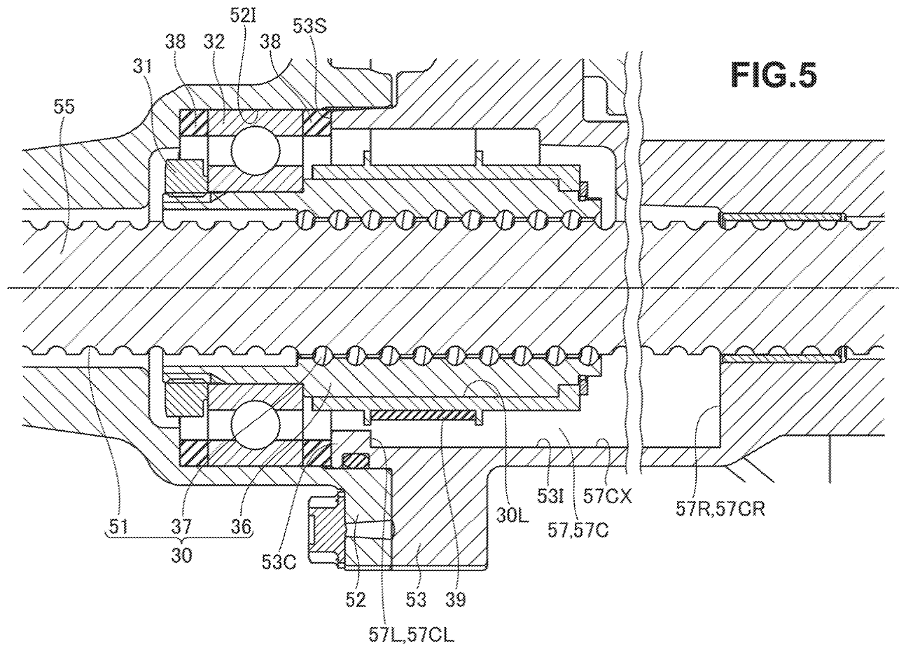

FIG. 5 is a diagram for describing a retaining portion 57C that is in a different form from those of the above-described retaining portions 57A and 57B. The retaining portion 57C illustrated in FIG. 5 has a first end portion 57CR located at the similar position to that of the above-described first end portion 57AR, but the form of a second end portion 57CL differs from those of above-described second end portions 57AL and 57BL. The second end portion 57CL of the retaining portion 57C has a position in the axial direction of the rack shaft 55 located at the belt-member-39 side relative to the position of the second end portion 57BL. In other words, the second end portion 57CL is located below the side face 39S of the belt member 39 at the pinion-shaft-21 side. That is, the position of the end surface 39S and the position of the second end portion 57CL in the axial direction of the rack shaft 55 are consistent with each other. In comparison with the retaining portion 57B illustrated in FIG. 4, the retaining portion 57C illustrated in FIG. 5 has a width (a length in the axial direction of the rack shaft 55) of a convexity 53C provided at an end of a bottom portion 57CX in the retaining portion 57 at the elastic-body-38 side wider than the width of the above-described concavity 53B. According to such a form, also, it becomes easy to trap water in the retaining portion 57C by what corresponds to the height of the convexity 53C. Consequently, since it becomes easy to prevent the belt member 39 from being soaked with water, the electrically-assisted power steering device 100 can maintain the performance under a freezing-temperature environment.

### 2. Second Embodiment

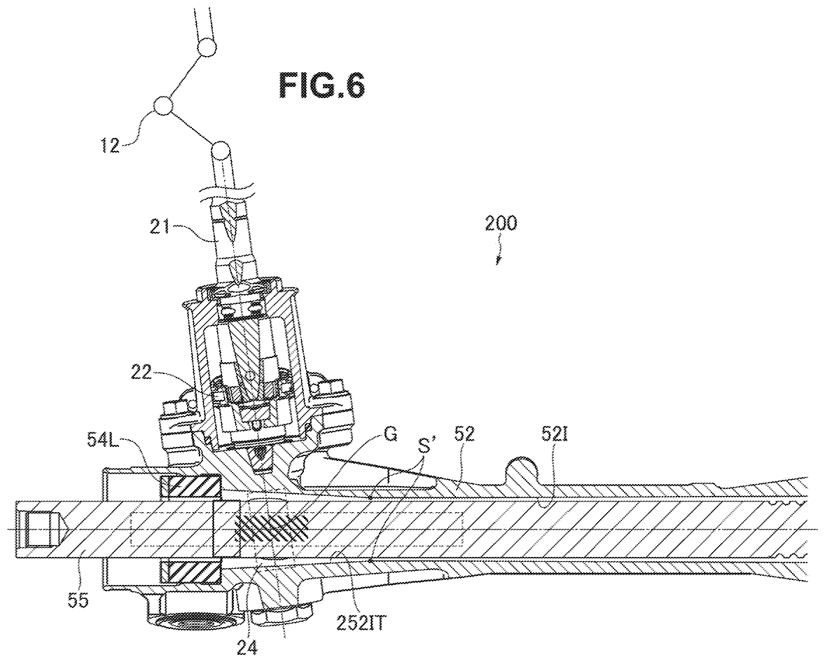

FIG. 6 is a diagram illustrating a part of an electrically-assisted power steering device 200 that is an example steering apparatus according to a second embodiment of the present disclosure. The electrically-assisted power steering device 200 employs the same structure as that of the above-described electrically-assisted power steering device 100 except that the groove portion 52IG is not provided. In FIG. 6, the same component as that of the electrically-assisted power steering device 100 will be denoted by the same reference numeral utilized in FIG. 3, and the detailed description thereof will be omitted.

Instead of the first housing 52 of the electrically-assisted power steering device 100, the electrically-assisted power steering device 200 includes a first housing 252. As illustrated in FIG. 6, the first housing 252 does not include a structural component corresponding to the above-described groove portion 52IG, but includes an inclined portion 252IT corresponding the inclined portion 52IT, and a start point S′ of the inclined portion 252IT is present at the second-housing side relative to the meshed portion G. By providing the inclined portion 252IT, even if water enters in the first housing 252, the water trapped below the rack shaft 55 is prevented from moving toward the unillustrated second-housing side. This reduces the amount of water that flows in the second housing from the first housing 252, and thus the ball screw and the belt member retained in the second housing are suppressed to be soaked with such water. Hence, according to the second embodiment of the present disclosure, the electrically-assisted power steering device 200 can be provided which can maintain the performance under a freezing-temperature environment.

### 3. Third Embodiment

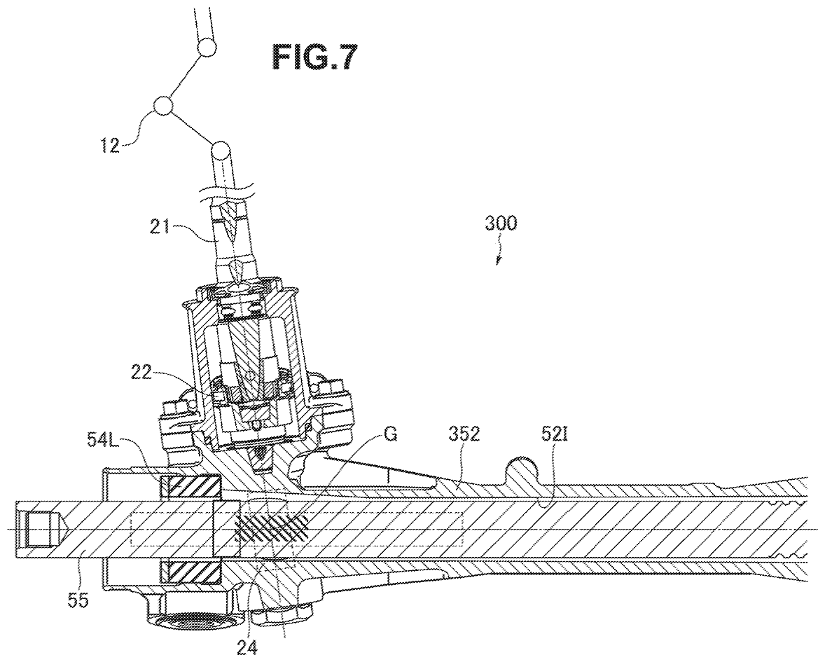

FIG. 7 is a diagram illustrating a part of an electrically-assisted power steering device 300 that is an example steering apparatus according to a third embodiment of the present disclosure. The electrically-assisted power steering device 300 employs the same structure as that of the above-described electrically-assisted power steering device 200 except that no inclined portion 252IT is provided. In FIG. 7, the same structural component as that of the electrically-assisted power steering device 200 will be denoted by the same reference numeral in FIG. 6, and the detailed description thereof will be omitted.

The electrically-assisted power steering device 300 includes, instead of the first housing 252 of the electrically-assisted power steering device 200, a first housing 352. As illustrated in FIG. 7, the first housing 352 does not employ a structure corresponding to above-described inclined portion 252IT. Hence, unlike the above-described electrically-assisted power steering devices 100 and 200, according to the electrically-assisted power steering device 300, the first housing 352 does not include the inclined portion or the groove portion that makes it difficult for water entering in the first housing 352 to move toward the second-housing side. Although such a form is employed, the second housing (unillustrated) of the electrically-assisted power steering device 300 has a retaining portion that can trap water like the electrically-assisted power steering devices 100 and 200. Hence, the ball screw and the belt member retained in the second housing are suppressed to be soaked with water. Therefore, according to the third embodiment of the present disclosure, the electrically-assisted power steering device 300 can be provided which can maintain the performance under a freezing-temperature environment.

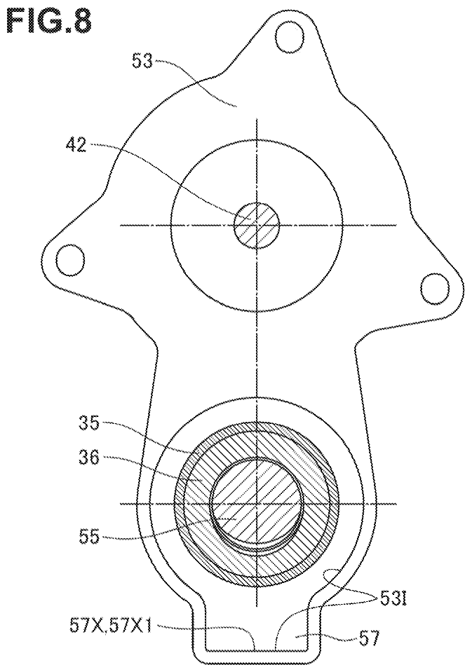

In the above description regarding the present disclosure, a form in which the retaining portions 57A, 57B, and 57C (those may be collectively referred to as the “retaining portion 57” below, and the bottom portion of the retaining portion 57 may be referred to as the “bottom portion 57X”) has been described as examples. A form that the bottom portion 57X can take will be described below with reference to FIG. 8 to FIG. 10.

FIG. 8 is a diagram illustrating a cross section taken along a line VIII-VIII in FIG. 1. The bottom portion 57X of the retaining portion 57 may be in, for example, a form of a bottom portion 57X1 illustrated in FIG. 8. That is, the bottom 57X has the width in the vehicle back-and-forth direction smaller than the inner diameter of the driven pulley 35 and the outer diameter of the ball housing 36, thus being in a convex shape protruding toward the lower side of the second housing 53. By applying such a form, water can be trapped in the retaining portion 57 that protrudes downwardly. Hence, an electrically-assisted power steering device can be provided which can maintain the performance under a freezing-temperature environment by providing such a retaining portion 57.

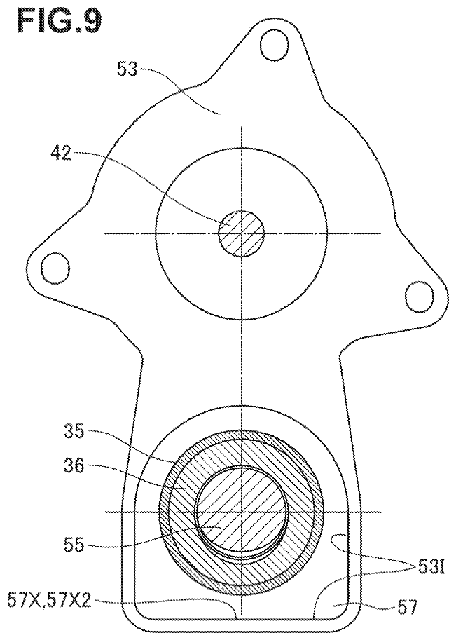

FIG. 9 is a diagram illustrating a cross section taken along a line IX-IX in FIG. 1. The bottom portion 57X of the retaining portion 57 may be in, for example, a form of a bottom portion 57X2 illustrated in FIG. 9. That is, the bottom 57X can have the width in the vehicle back-and-forth direction substantially the same as the width in the vehicle back-and-forth direction at a portion of the second housing 53 where the driven pulley 35 is retained. Such a form can also trap water in the retaining portion 57. Hence, an electrically-assisted power steering device can be provided which can maintain the performance under a freezing-temperature environment by providing such a retaining portion 57.

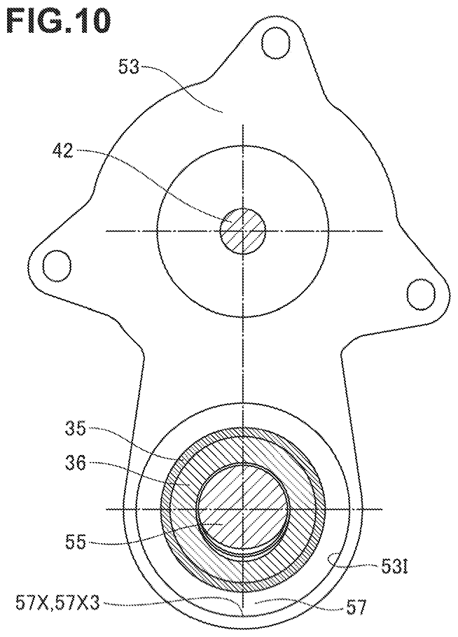

FIG. 10 is a diagram illustrating a cross section taken along a line X-X in FIG. 1. The bottom portion 57X of the retaining portion 57 may be in, for example, a form of a bottom portion 57X3 illustrated in FIG. 10. That is, the bottom portion 57X can be formed in a curved surface shape protruding downwardly. Such a form can also trap water in the retaining portion 57. Hence, an electrically-assisted power steering device can be provided which can maintain the performance under a freezing-temperature environment by providing such a retaining portion 57.

The above-described electrically-assisted power steering devices 100, 200 and 300 accomplish the following advantageous effects. In the following description, the first end portions 57AR, 57BR, and 57CR may be collectively referred to as the “first end portion 57R”, and the second end portions 57AL, 57BL, and 57CL may be collectively referred to as the “second end portion 57L”.

Each of the electrically-assisted power steering devices 100, 200 and 300 includes the rack shaft 55 movable in the vehicle widthwise direction, the pinion shaft 21 meshed with the rack shaft 55, the first housing 52 that retains therein the rack shaft 55 and the pinion shaft 21, the ball screw 30 that transmits drive force generated by the motor 41 to the rack shaft 55, and the second housing 53 that retains therein the ball screw 30. The retaining portion 57 capable of storing water is provided at the inner circumferential surface 531 of the second housing 53. The lower end surface 57X of the retaining portion 57 is located below at least the lower end surface 30L of the ball screw 30. The first end portion 57R of the retaining portion 57 in the axial direction of the rack shaft 55 is located between the belt member 39 that links the ball screw 30 with the motor 41 and the rack end stopper 54R at the motor-41 side.

By providing the retaining portion 57 below the lower end surface 30L of the ball screw 30, in other words, below the lower end surface of the belt member 39, water that enters in the second housing 53 can be trapped in the retaining portion 57. Hence, in comparison with a case in which there is no retaining portion 57, this makes it difficult for the water entering in the second housing 53 to contact the belt member 39. Since the water is not likely to contact the belt member 39, the belt member 39 is facilitated to actuate even under a freezing low-temperature environment. Accordingly, the electrically-assisted power steering devices 100, 200 and 300 can be provided which can maintain the performance under a freezing temperature environment.

Moreover, in each of the electrically-assisted power steering devices 100, 200 and 300, the second end portion 57L of the retaining portion 57 which is located at the belt-member-39 side relative to the first end portion 57R in the axial direction of the rack shaft 55 may be located at the pinion-shat-21 side relative to both side faces of the belt member 39 in the axial direction, and may be an opening opened in the end surface 53S of the second housing 53 at the first-housing-52 side.

According to such a form, since the retaining portion 57 is provided below the lower end surface of the belt member 39, water entering in the second housing 53 is not likely to contact the belt member 39. Accordingly, the electrically-assisted power steering devices 100, 200 and 300 can be provided which can maintain the performance under a freezing-temperature environment.

Moreover, in each of the electrically-assisted power steering devices 100, 200 and 300, the second end portion 57L of the retaining portion 57 located at the belt-member-39 side relative to the first end portion 57R in the axial direction of the rack shaft 55 may have the same position in the axial direction of the rack shaft 55 as the position of the side face 39S of the belt member 39 at the pinion-shaft-21 side.

According to such a structure, also, since the retaining portion 57 is provided below the lower end surface of the belt member 39, the water that enters in the second housing 53 is not likely to contact the belt member 39. Accordingly, the electrically-assisted power steering devices 100, 200 and 300 can be provided which can maintain the performance under a freezing-temperature environment.

Furthermore, in each of the electrically-assisted power steering devices 100, 200 and 300, the second end portion 57L of the retaining portion 57 located at the belt-member-39 side relative to the first end portion 57R in the axial direction of the rack shaft 55 may have a position in the axial direction of the rack shaft 55 located between the position of the side face 39S of the belt member 39 at the pinion-shaft-21 side and the end surface 53S of the second housing 53 at the pinion-shaft-21 side.

According to such a structure, also, since the retaining portion 57 is provided below the lower end surface of the belt member 39, the water that enters in the second housing 53 is not likely to contact the belt member 39. Accordingly, the electrically-assisted power steering devices 100, 200 and 300 can be provided which can maintain the performance under a freezing-temperature environment.

Still further, in the electrically-assisted power steering devices 100 and 200, it is preferable that the inner circumferential surface 521 of the first housing 52 facing with the rack shaft 55 should include the inclined portion 52IT or 252IT that decreases the internal diameter toward the motor-41 side from the pinion-shaft-21 side, and the start point S or S′ of the inclined portion 52IT or 252IT should be located at the motor-41 side relative to the meshed portion G where the tooth 55T of the rack shaft 55 and the tooth of the pinion shaft 21 are meshed with each other.

According to the electrically-assisted power steering devices 100 and 200 with such a structure, in order to move toward the second-housing-53 side, it is necessary for water that enters in the first housing 52 or 252 to move beyond the inclined portion 52IT or 252IT. Since the water that enters in the first housing 52 or 252 is trapped below the rack shaft 55, the inclined portion 52IT or 252IT serves as uphill for such water. It is difficult for such water to go over the uphill. Since it is difficult for the water that enters in the first housing 52 or 252 to move to the second housing 53 because the first housing 52 or 252 includes the inclined portion 52IT or 252IT, the amount of water that enters in the second housing 53 can be reduced. This makes it further difficult for such water to contact the belt member 39, the belt member 39 is not likely to become a state difficult to actuate under a low-temperature environment at which freezing occurs. Hence, by adopting a structure in which the inclined portion 52IT or 252IT is provided, the electrically-assisted power steering devices 100 and 200 can be provided which is further facilitated to maintain the performance under a freezing-temperature environment.

Yet still further, in the electrically-assisted power steering device 100 that includes the inclined portion 52IT, it is preferable that the inner circumferential surface 521 of the first housing 52 which faces with the rack shaft 55 and which is located at least below the rack shaft 55 should include the groove portion 52IG which is located at the pinion-shaft-21 side relative to the start point S and which has an opened upper surface.

According to the electrically-assisted power steering device 100 in such a structure, water that attempts to go over the inclined portion 52IT to move can be trapped in the groove portion 52IG. Since it becomes difficult for the water that enters in the first housing 52 to move to the second housing 53 by providing the groove portion 52IG, the amount of water that enters in the second housing 53 can be reduced. This further makes it difficult for the water to contact the belt member 39, and thus the belt member 39 is not likely to become a state difficult to actuate under a low-temperature environment at which freezing occurs. Hence, by adopting a structure provided with the groove portion 52IG, the electrically-assisted power steering device 100 can be provided which is further facilitated to maintain the performance under a freezing-temperature environment.

### REFERENCE SIGNS LIST

G Meshed portion
S and S′ Start point
11 Steering wheel
12 Intermediate shaft
21 Pinion shaft
22 Torque sensor
24 Pinion tooth
30 Ball screw
30L Lower end surface of ball screw
31 Screw
32 Bearing
35 Driven pulley
36 Ball housing
37 Ball
38 Elastic body
39 Belt member
39S Side face of belt member
41 Motor (drive source)
42 Motor shaft
45 Drive pulley
51 Ball screw
52, 252 and 352 First housing
521 Inner circumferential surface of first housing
52IG Inner circumferential surface groove portion of first housing
52IT and 252IT Inner circumferential surface tapered portion (inclined portion) of first housing
53 Second housing
53B and 53C Convexity
531 Inner circumferential surface of second housing
53S End surface of second housing
54L Rack end stopper
54R Rack end stopper (rack end stopper at drive-source side)
55 Rack shaft (turning shaft)
55T Rack tooth (tooth of turning shaft)
57, 57A, 57B and 57C Retaining portion
57AR, 57BR, 57CR and 57R First end portion of retaining portion
57AL, 57BL, 57CL and 57L Second end portion of retaining portion
57X, 57X1, 57X2 and 57X3 Bottom portion (lower end surface of retaining portion)
60 Transmission mechanism
70 Transmission belt mechanism
100, 200 and 300 Electrically-assisted power steering device (steering apparatus)
110 Wheel
120 Knuckle
130 Tie rod end

1. A steering apparatus comprising:
a turning shaft movable in a vehicle widthwise direction;
a pinion shaft meshed with the turning shaft;
a first housing that retains therein the turning shaft and the pinion shaft;
a ball screw that transmits drive force generated by a drive source to the turning shaft; and
a second housing that retains therein the ball screw,
wherein a retaining portion capable of storing water is provided at an inner circumferential surface of the second housing,
wherein a lower end surface of the retaining portion is located below at least a lower end surface of the ball screw
wherein a first end portion of the retaining portion in an axial direction of the turning shaft is located between a belt member that links the ball screw with the drive source and a rack end stopper at a drive-source side, and
wherein a second end portion of the retaining portion located at a belt-member side relative to the first end portion in the axial direction of the turning shaft has a same position in an axial direction of the steering shaft as a position of a side face of the belt member a pinion-shaft side.

2-6. (canceled)
